(19) United States
(12) Patent Application Publication
(10) Pub. No.: US 2002/0190593 A1
(43) Pub. Date: Dec. 19, 2002

(54) Endshield for an electric motor

(76) Inventors: Brian D. Franz, Monroeville, IN (US); Son Huynh, Fort Wayne, IN (US); L. Edwin Fisher, Fort Wayne, IN (US); Richard Steele, Fort Wayne, IN (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 09/681,866

(22) Filed: Jun. 19, 2001

(51) Int. Cl. H02K 5/00

(52) U.S. Cl. 310/91

(57) ABSTRACT

An endshield for an electric motor, the end shield having a body and at least one mounting ear extending from the body. The at least one mounting ear includes a slot.

### BACKGROUND OF INVENTION

This invention relates generally to electric motors and more specifically to endshields for electric motors.

Known capacitor motors, for example capacitor-start motors, permanent split capacitor motors, and two-valve capacitor motors, include an endshield and a separate capacitor cover. The capacitor cover typically is a rubber or plastic boot that covers the wires and live terminals of the capacitor. The separate capacitor cover, or boot, adds an additional part to a capacitor motor assembly and thus adds additional cost, labor and time to the assembly of capacitor motors.

In addition, known electric motor assemblies may be difficult to remove from the appliance or machine to which such assemblies are connected. Typically, to remove an electric motor assembly from a machine or an appliance, a plurality of mounting bolts or nuts must be completely removed before the assembly can be extracted from the machine or appliance.

### SUMMARY OF INVENTION

In one aspect, an endshield for an electric motor is provided which comprises a body and a capacitor cover extending radially outward from the body.

In another embodiment, an endshield for an electric motor is provided which comprises a body and at least one mounting ear extending from the body. The at least one mounting ear includes a slot.

In a further embodiment, an endshield for an electric motor is provided which comprises a body and at least one mounting ear extending from the body. The at least one mounting ear includes a first side and an opening extending through the at least one mounting ear. The at least one mounting ear further includes a slot extending therethrough from the opening through the first side.

In a further embodiment, an electric motor assembly is provided which comprises a motor housing, and a stator mounted in the housing and comprising a bore therethrough. The stator includes at least one main winding and at least one auxiliary winding. The assembly further comprises a rotor core rotatably mounted in the housing and extending through the stator bore, a capacitor in series with the auxiliary winding, and an endshield connected to the housing. The endshield includes a body and at least one mounting ear extending from the body. The at least one mounting ear includes a slot.

In yet a further embodiment, a method of mounting an electric motor assembly to a machine is provided. The electric motor assembly includes a motor housing, a capacitor having at least one terminal, and an endshield. The endshield includes a body. The method includes providing a capacitor cover extending from the endshield body and mounting the endshield to the motor housing such that the capacitor cover covers the at least one capacitor terminal.

### BRIEF DESCRIPTION OF DRAWINGS

FIG. 1 is a front perspective view illustrating an endshield in accordance with one embodiment of the present invention.

FIG. 2 is a back perspective view of the endshield shown in FIG. 1.

FIG. 3 is a cross-section illustrating a mounting ear of the endshield shown in FIG. 1.

FIG. 4 is a side view illustrating a motor assembly in accordance with one embodiment of the present invention.

FIG. 5 is a front view illustrating of the motor assembly shown in FIG. 4.

### DETAILED DESCRIPTION

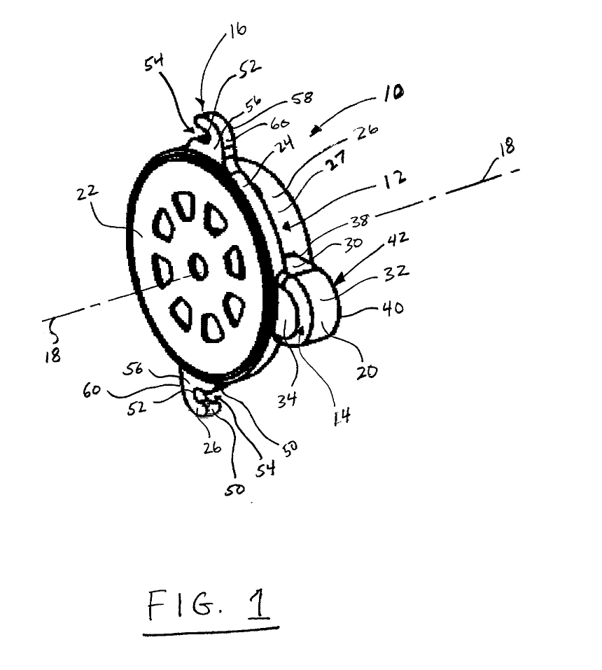

Referring now to FIG. 1, one embodiment of an endshield 10 is illustrated that includes a body 12, a capacitor cover 14 extending radially from body 12, a pair of mounting ears 16, and a central axis 18 extending through a length of endshield 10. Body 12 includes a top wall 22, having a top sidewall 24, and a bottom wall 26 connected to top 22 and extending outwardly from top 22. Capacitor cover 14 is connected to bottom wall 26 and extends outwardly from an outer face 27 of bottom wall 26.

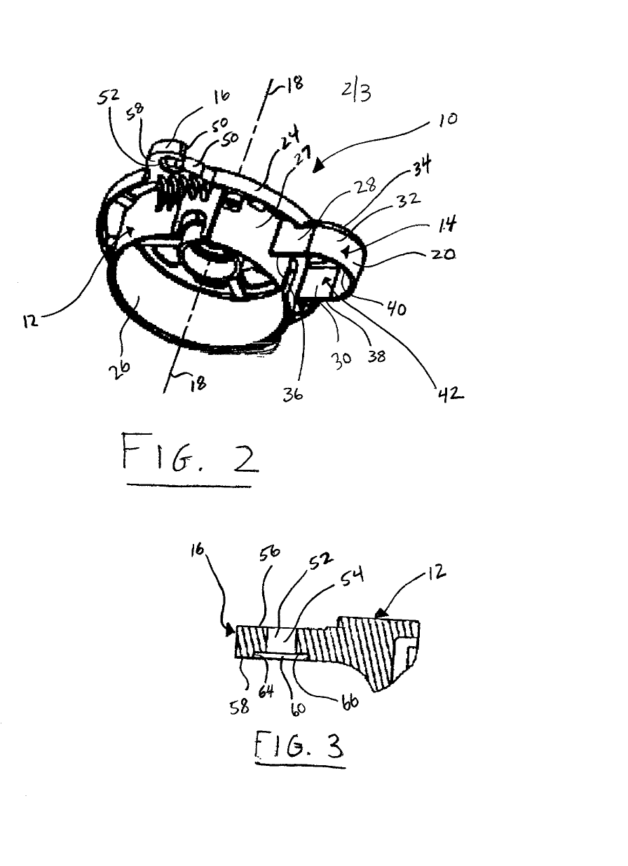

Referring now to FIG. 2, capacitor cover 14 includes a wall 20 having a first wall portion 28 extending outwardly from outer face 27 of body 12, a second wall portion 30 extending outwardly from outer face 27, a third wall portion 32 and a top 34. Third wall portion 32 connects first wall portion 28 to second wall portion 30. Top 34 extends outwardly from, and is connected to, top sidewall 24. Top 34 is further connected to first wall portion 28, second wall portion 30 and third wall portion 32.

It will be understood by one skilled in the art that first wall portion 28, second wall portion 30, third wall portion 32 and top 34 may be any desired shape. For example, in one embodiment, the shape of any of first wall portion 28, second wall portion 30, third wall portion 32 and top 34 may be arcuate. In another embodiment, wall 20 of capacitor cover 12 includes only one wall portion that is the shape of a partial sphere extending outwardly from body 12. In yet another embodiment, wall 20 includes only a top extending from body 12 and a first arcuate shaped wall section extending from body 12. Furthermore, although capacitor cover 14 is shown in FIGS. 1 and 2 to extend outwardly from outer face 27 and top sidewall 24 of endshield body 12, it will be understood by one skilled in the art that capacitor cover 14 may extend from any portion of endshield body 12. For example, in one embodiment, capacitor cover 14 extends outwardly from top wall 22 of endshield body 12. Additionally, although capacitor cover 14 is shown in FIGS. 1 and 2 to extend radially outward from endshield body 12, it will be understood by one skilled in the art that capacitor cover 14 may extend outwardly from endshield body 12 in non-radial directions.

First wall portion 28, second wall portion 30 and third wall portion 32 each include first ends 36, 38, 40, respectively, which define a capacitor cover opening 42. Cover opening 42 is sized to receive terminals (not shown) and wiring (not shown) of a capacitor (not shown) such that the terminals and wiring are covered and within UL requirements. In one embodiment, the capacitor terminals are insulated to keep electrical clearance between the terminals and capacitor cover 12. Because capacitor cover 12 is integral with endshield 10, a separate capacitor cover is not required when an electric motor assembly (not shown) is connected to endshield 10. Thus, endshield 10 saves motor assembly time, cost and labor that a separate capacitor cover may necessitate.

Mounting ears 16 provide a secure mounting structure for mounting a motor assembly (not shown), including endshield 10, to an appliance (not shown) or a machine (not shown). Although two mounting ears are shown in FIGS. 1 and 2, it will be understood by one skilled in the art that endshield 10 may include any number of mounting ears 16 such as one or more than two. Mounting ears 16 are radially spaced around the periphery of endshield body 12 and are connected to, and extend outwardly from, top sidewall 24. In an alternative embodiment, mounting ears 16 are connected to bottom wall 26 of endshield body 12 and extend outwardly from outer face 27. Further, it will be understood by one skilled in the art that mounting ears 16 may be located anywhere on endshield 10 that permits a motor assembly (not shown), including endshield 10, to be mounted to a machine (not shown) or an appliance (not shown).

Mounting ears 16 include a first side 50, an opening 52, a slot 54, a front face 56, a back face 58, and a second side 60. Opening 52 is sized and shaped to receive a mounting bolt (not shown) or stud (not shown) and extends completely through mounting ear 16. Slot 54 extends completely through mounting ear 16 from opening 52 through first side 50 such that slot 54 forms a continuous opening through mounting ear 16 from first side 50 to opening 52. In an alternative embodiment, mounting ear 16 does not include opening 52, but rather only slot 54, sized and shaped to receive a mounting bolt or stud (not shown).

It is to be understood by one skilled in the art that mounting ears 16 may be any desired size and shape. For example, in one embodiment (shown in FIGS. 1 and 2), mounting ears 16 are generally c-shaped. In an alternative embodiment, mounting ears 16 are generally rectangular-shaped. The above embodiments are exemplary only and are not meant to be inclusive.

Additionally, endshield 10 may be fabricated from any material and any process producing an endshield suitable for the desired motor assembly. For example, in one embodiment, endshield 10 is a stamped steel endshield. In another embodiment, endshield 10 is a cast metal endshield. The above embodiments are exemplary only and are not meant to be inclusive.

FIG. 3 is a cross-section illustrating mounting ear 16 of endshield 10. Mounting ear 16 is shown to include opening 52, slot 54, front face 56 and back face 58. Mounting ear 16 further includes an annular recess 62 having a sidewall 64 and a recessed surface 66. In one embodiment, recess 62 is concentric with opening 52 and extends through back face 58 and a portion of mounting ear 16 to recessed surface 66. Annular recess 62 is sized to receive a fastener, such as a bolt head or a nut, such that recess 62 prevents the bolts from exiting slots 54 when a motor assembly (not shown), including endshield 10, is mounted to a machine or an appliance. Thus, annular recess 62 prevents the motor assembly from dismounting from the machine or appliance when the bolts are snuggly tightened. It will be understood that recess 62 may be any size and shape suitable to prevent the motor assembly from dismounting the machine or appliance. For example, in an alternative embodiment, recess 62 is rectangular. In yet another alternative embodiment, mounting ear 16 does not include recess 62.

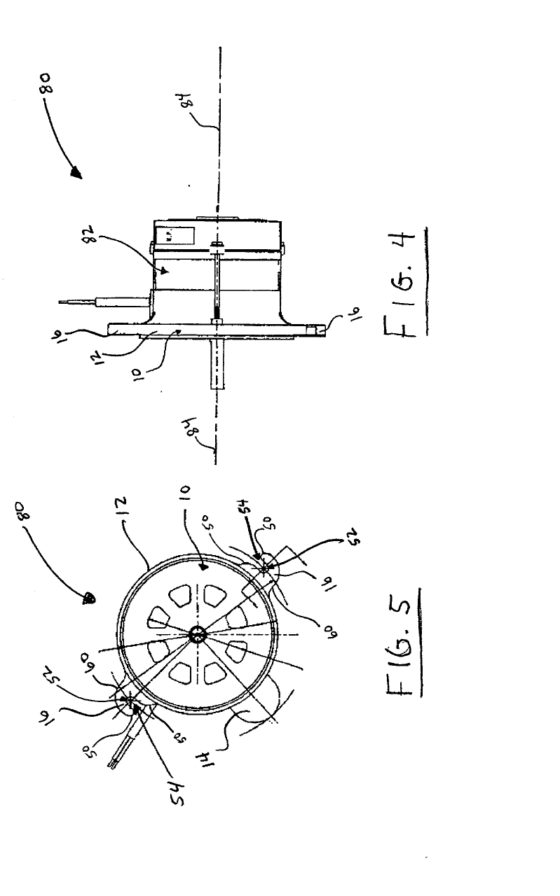

FIG. 4 is side view illustrating one embodiment of a motor assembly 80 including a motor housing 82, a stator (not shown) having a bore therethrough and mounted in housing 82, a rotor core (not shown) rotatably mounted in housing 82 and extending through the stator bore, a central axis 84 extending through a length of housing 82, a capacitor (not shown), and end shield 10. The stator includes at least one main winding (not shown) and at least one auxiliary winding (not shown). The capacitor is wired in series with the auxiliary winding.

Referring now to FIG. 5, endshield 10 includes capacitor cover 14 extending from body 12 and mounting ears 16 extending from body 12. Slots 54 of mounting ears 16 are shown as pointing in a generally counterclockwise radial direction, away from second side 60. Because slots 54 form a continuous opening through mounting ear 16 from opening 52 through first side 50, and because slots 54 point in generally the same radial direction, motor assembly 80, including endshield 10, can be easily removed from a machine (not shown) or appliance (not shown) by loosening the mounting bolts (not shown) or nuts (not shown) and rotating motor assembly 80, clockwise as shown in FIG. 5, on central axis 84. Endshield 10 thus permits assembly and disassembly of motor assembly 80, including endshield 10, without complete removal of the mounting bolts or nuts. In an alternative embodiment, endshield 10 includes two mounting ears 16 having slots 54 that point in generally opposite radial directions. In such an embodiment, motor assembly 80, including endshield 10, can be easily removed by loosening the mounting bolts (not shown) or nuts (not shown), and moving motor assembly 80 in a direction such that the mounting bolts or nuts can exit slots 54.

A method of mounting an electric motor assembly 80 (shown in FIGS. 4 and 5) to a machine (not shown) includes providing capacitor cover 14 (shown in FIG. 5) extending from endshield body 12 (shown in FIGS. 4 and 5) and mounting endshield 10 to motor housing 82 (shown in FIGS. 4 and 5) such that capacitor cover 14 covers at least one capacitor terminal (not shown) and at least one capacitor wire (not shown).

While the invention has been described in terms of various specific embodiments, those skilled in the art will recognize that the invention can be practiced with modification within the spirit and scope of the claims.

1. An endshield for an electric motor, said end shield comprising:
a body; and
a capacitor cover extending radially outward from said body.

2. An endshield in accordance with claim 1 wherein said body further comprises at least one mounting ear extending from said body, said at least one mounting ear having a slot.

3. An endshield in accordance with claim 1 wherein said capacitor cover comprises a partially spherical wall extending from said body.

4. An endshield in accordance with claim 1 wherein said capacitor cover further comprises a wall extending from said body and a top extending from said body, said top connected to said wall.

5. An endshield in accordance with claim 4 wherein said wall comprises a first wall portion extending from said body, a second wall portion extending from said body and a third wall portion, said third wall portion connecting said first wall portion and said second wall portion.

6. An endshield in accordance with claim 2 wherein said at least one mounting ear further comprises a recess sized to receive a fastener.

7. An endshield for an electric motor, said end shield comprising:
a body; and
at least one mounting ear extending from said body, said at least one mounting ear having a slot.

8. An endshield in accordance with claim 7 wherein said at least one mounting ear further comprises an opening extending therethrough and a first side, said slot extending through said mounting ear from said opening through said first side.

9. An endshield in accordance with claim 8 wherein said at least one mounting ear generally c-shaped.

10. An endshield in accordance with claim 7 wherein said endshield comprises a plurality of mounting ears each having a slot.

11. An endshield in accordance with claim 10 wherein said plurality of slots pointing in generally the same radial direction.

12. An endshield in accordance with claim 7 wherein said at least one mounting ear further comprises a recess sized to receive a fastener.

13. An endshield for an electric motor, said endshield comprising a body and at least one mounting ear extending from said body, said at least one mounting ear having a first side and an opening extending through said at least one mounting ear, said at least one mounting ear further comprising a slot extending therethrough from said opening through said first side.

14. An electric motor assembly comprising:
a motor housing;
a stator mounted in said housing and comprising a bore therethrough, said stator having at least one main winding and at least one auxiliary winding;
a rotor core rotatably mounted in said housing and extending through said stator bore;
a capacitor in series with said auxiliary winding; and
an endshield connected to said housing, said endshield comprising a body and at least one mounting ear extending from said body, said at least one mounting ear having a slot.

15. An electric motor assembly in accordance with claim 14 wherein said endshield further comprises a capacitor cover extending from said body.

16. An electric motor assembly in accordance with claim 15 wherein said capacitor cover comprises a top extending from said body, a first wall portion extending from said body, a second wall portion extending from said body and a third wall portion, said third wall portion connecting said first wall portion and said second wall portion.

17. An electric motor assembly in accordance with claim 14 wherein said at least one mounting ear further comprising an opening extending therethrough and a first side, said slot extending through said mounting ear from said opening through said first side.

18. A method of mounting an electric motor assembly to a machine, the electric motor assembly including a motor housing, a capacitor having at least one terminal, and an endshield, the endshield including a body, said method comprising:
providing a capacitor cover extending from the endshield body; and
mounting the endshield to the motor housing such that the capacitor cover covers the at least one capacitor terminal.

19. A method in accordance with claim 18 wherein providing a capacitor cover extending from the endshield body further comprises providing a capacitor cover having a top extending from the body, a first wall portion extending from the body, a second wall portion extending from the body, and a third wall portion connecting the first wall portion and the second wall portion.

20. A method in accordance with claim 18 wherein the capacitor includes a plurality of wires, said method further comprises mounting the endshield to the motor housing such that the capacitor cover covers the capacitor wires.

21. A method in accordance with claim 20 wherein mounting the endshield to the motor housing further comprises mounting the endshield to the motor housing such that the terminals and wires are covered and within UL requirements.
